(19) United States
(12) Patent Application Publication
(10) Pub. No.: US 2013/0169813 A1
(43) Pub. Date: Jul. 4, 2013

(54) DEVICE AND METHOD FOR MEASURING TIRE PARAMETERS OF A VEHICLE

(71) Applicant: Frank Schaefer, Weilheim (DE)

(72) Inventor: Frank Schaefer, Weilheim (DE)

(73) Assignee: MAHA MASCHINENBAU HALDENWANG GMBH & CO. KG, Haldenwang (DE)

(21) Appl. No.: 13/809,056

(22) PCT Filed: Jul. 11, 2011
(86) PCT No.: PCT/EP2011/061758

§ 371 Date: Mar. 26, 2013

(30) Foreign Application Priority Data
Jul. 9, 2010 (DE) 10 2010 026 729.5

(51) Int. Cl. B60C 23/02

(52) U.S. Cl. CPC B60C 23/02
USPC 348/148

(57) ABSTRACT

A device for measuring tire parameters of a vehicle, comprising a detector for detecting a tire pressure of the vehicle, a measuring system for detecting a tire profile depth of the vehicle, and an output unit for outputting measured tire parameters that include and/or take into account the tire pressure and the tire profile depth. The detector and the measuring system have a measuring arrangement which is designed to be driven over by the vehicle and which is designed to measure the tire pressure as well as the tire profile depth in a moving vehicle, and the output unit is designed to display a result of the measurement such that an operating person that drives the vehicle can detect the measurement in the vehicle or from the vehicle directly after driving over the measuring arrangement.

### BACKGROUND OF THE INVENTION

The present invention relates to an apparatus for measuring tire parameters for a vehicle according to the preamble of the main claim and to a method for measuring and outputting tire parameters for a vehicle.

The prior art discloses numerous practices for measuring tire parameters in the form of a respective tire pressure and a tire profile depth, particularly in connection with HGV fleets or the like having a relatively large number of vehicles and vehicle tires.

It is thus customary, for example in the aforementioned commercial context of HGV fleets, to check the tire parameters periodically, e.g. on a quarterly basis, as part of what are known as fleet checks, that is to say measuring routines relating to a fleet, which are typically carried out by service providers, this involving a tire pressure being captured by measuring appliances, which are usually fitted to the tire valve manually, and the tire profile depth being checked in parallel by virtue of a visual or gauge test, in otherwise known fashion. Such checks take place regularly not just on account of legal requirements; in particular commercial operators of HGV fleets also make use of the opportunity to regularly check the tire air pressure in order to ensure that a minimum air pressure optimizing fuel consumption is maintained.

The results of the tire parameters ascertained in the prescribed manner, typically by manual means, are then made available in the form of otherwise known measuring logs and subjected to data processing, particularly also within the context of relatively large HGV fleets. Nevertheless, the recording of these data also has a shared manual element, linked to the imponderables which are always possible in relation to spurious capture of data from recording and transmission errors.

The manually supported practice, known from the prior art, for measuring, recording and conditioning tire parameters for a vehicle opens up numerous further potential improvements besides the aforementioned error problems during measured value recording: firstly, it has been found to be a basis for the present invention that the typical fleet check intervals are inadequate in respect of optimized driving on an (HGV) vehicle tire profile; for example, if it is possible to identify at a checking appointment that a profile depth that is still present is probably not suitable to still retain the legally required minimum profile depth by the next scheduled checking appointment then the immediate changing of the vehicle tire would be initiated. Accordingly, the resource utilization in this regard is less than optimum. Secondly, it has been found in respect of the tire pressure of a vehicle tire that the checking intervals for a fleet check are unsuitable for always keeping the tire pressure at an optimum level, which means that typically vehicle tires always travel at under pressure (which is detrimental to consumption) for a period. At the same time, the costs associated with a fleet check prohibit said fleet check from being performed more frequently (i.e. at shorter intervals); this is governed not only by the costs which need to be expended for a respective service provider but also particularly by the idle times that are required, since at the time of the fleet check the vehicle (typically with further vehicles from the same fleet) is tied to a designated location without being able to be used.

The prior art also discloses isolated solutions which automate the traditional, largely manual measurement of tire parameters. Thus, an apparatus for measuring and capturing a profile depth of a vehicle tire has been described and protected for the applicant in the form of European Patent 1 952 092, for example, which records the actual parameters that are required for profile depth capture as intended, and ascertains a profile depth value therefrom, when a measurement arrangement is run over. However, this is an isolated special solution which is used specifically for moving traffic and provides tire profile depth information for monitoring authorities, for example.

An apparatus for measuring tire parameters for a vehicle according to the preamble of the main claim is known from WO 2006/003467 A1. This document particularly also reveals approaches to integrating various measuring processes and basically allowing various tire parameters to be established by driving on or running over individual capture means.

However, there continues to be a lack of an integrated system which particularly provides the potential to make the traditional procedure of a fleet check, described above, more efficient, without downtimes for the HGVs in question, more flexible in respect of air pressure and profile depth capture and also resource-saving, in terms of lowering fuel consumption and the optimum utilization of tire profiles of a vehicle tire, for example.

It is therefore an object of the present invention to provide an apparatus for measuring and outputting tire parameters for a vehicle which overcomes the disadvantages of the fleet check system known from the prior art, particularly on a flexible and real-time basis, independently of predetermined fleet bases and therefore without the need for long downtimes, allows the capture of tire parameters in the form of the tire pressure and the tire profile depth and accordingly provides the vehicle driver and/or other parties involved, for example a fleet manager of a vehicle fleet, with the measured tire parameters in the form of data on an ad-hoc basis, said data allowing a reaction at short notice. This reaction could then particularly also mean the replacement of a vehicle tire in situ and/or the raising of a tire pressure through the supply of air, should a predetermined threshold for a tire parameter as the output from the present apparatus be exceeded or undershot. The object is also not intended to require any complex or infeasible conversion or prior equipment of a vehicle; instead, the vehicle, as it is, is meant to be amenable to tire parameter measurement in accordance with the object.

### SUMMARY OF THE INVENTION

The foregoing object is achieved by the apparatus and by the method of the present invention. Within the context of the present invention, the functional features of the apparatus that are indicated on the basis of developments are particularly also deemed to be disclosed and claimed as developing method steps for the method according to the invention.

Advantageously, the invention provides means for capturing a tire pressure for the vehicle and also means for capturing a tire profile depth for the vehicle which synergistically interact such that they perform the capture for a moving vehicle, preferably during the same movement or run-over process by the vehicle over a suitable measuring arrangement. The first advantageous effect achieved by this is that the vehicle provided with the vehicle tires as measurement objects does not need to be stationary for the measuring process, but instead the measurement of both tire parameters—tire pressure and tire profile depth—is made possible during a (shared) movement or (run-over) driving process. This in turn means that a user is not required outside the vehicle, for example in order to fit a tire pressure measuring hose, as required in the traditional prior art, or to measure a profile depth using a template. On the contrary, the invention allows the parameters to be captured and made available to the vehicle driver directly or indirectly, by means of the data transmission provided according to the invention, merely by running over a suitable measuring arrangement in a suitable manner.

An additional advantage achieved within the context of the invention is that the vehicle in question does not need to undergo any kind of conversion or prior equipment measures; instead, a standard, unmodified HGV or similar vehicle can run over the apparatus according to the invention in the manner intended and can prompt the inventive measurement of the tire parameters.

Within the context of particularly preferred developments of the invention, the apparatus according to the invention is also configured such that tire pressure and tire profile depth are measured by the respective capture means during the same movement or (run-over) driving process by the vehicle. This then additionally optimizes the measuring period required, since it is ideally possible for the vehicle driver to avoid maneuvering complexity or the like, for example.

It has been found to be advantageous within the context of implementing the apparatus according to the invention to perform the inventive measurement of the tire pressure on the basis of a force measurement which a vehicle tire in question exerts on underlying pressure or force measuring means while they are run over. A critical aspect in this case is the insight—provided and claimed on the basis of developments—that an ascertained vehicle tire pressure is dependent on a current tire temperature; since, as intended within the inventive context, the tire pressure capture for the vehicle (for one or more vehicle tires on the vehicle) can take place at any suitable time during HGV operation, there is particularly the opportunity to factor in the circumstance that the relevant tire has an increased operating temperature after a long journey, said increased operating temperature—on the basis of developments—being captured by the tire temperature capture means and then being factored in as compensation when capturing the tire pressure.

Since the present invention involves the tire pressure being captured and also the tire profile depth being captured while the vehicle is moving, it is advantageous on the basis of developments for this tire temperature measurement also to be provided such that it can take place during this movement. Accordingly, developments claim that the temperature capture be performed contactlessly, typically in a manner implemented by means of infrared temperature measurement and in a manner directed onto a side of a vehicle tire that is to be measured, for example.

Within the context of preferred forms of implementation of the invention, the vehicle pressure is ascertained by means of the aforementioned force measurement, by establishing what is known as the contact area of the vehicle tire, namely an effective contact face of the vehicle tire which results at the point of transition between the vehicle tire and the underlying ground. Within the context of preferred forms of implementation of the invention, the aforementioned force or pressure measurement of the moving vehicle beneath the vehicle tire (to be more precise: when a relevant force measuring arrangement is being run over) then allows a length of this contact area face to be captured (the term “length” being defined in the direction of run-over or travel). The measurement that is required for measuring the width of the contact area face is carried out optically within the context of preferred exemplary embodiments, wherein—in a typical form of implementation—an optical measuring and/or image capturing unit which has its end (that is to say in the direction of the running surface) directed onto a vehicle tire that is to be measured is suitable, in otherwise known fashion, for establishing a face width of the contact area (in this regard, the suitability of the apparatus described in the aforementioned EP 1 952 092 for establishing a contact width or contact area width of a vehicle tire by means of the optical means described therein should be pointed out). Alternatively, it is also possible to use the optical means to ascertain the contact area length over the course of time for a plurality of measurements (or just with one optical measurement).

Within the context of preferred developments of the invention, it is therefore then a synergistic possibility to additionally use the means used for optically capturing the tire profile depth of the vehicle when driving or when running over the measuring arrangement in order to establish the contact area width (possibly also contact area length) which is required for tire pressure capture, so that within the context of the present invention it is possible to provide an apparatus which integratively and synergistically combines the systems involved to achieve the objects according to the invention.

Within the context of preferred developments of the invention, a vehicle identification unit is provided which senses at least one vehicle identification (typically a front and/or rear license plate as an explicitly identifying vehicle license number for the vehicle). According to the invention, this is advantageously accomplished by optical image capture means which allow electronic coding of the respective vehicle license number in otherwise known fashion from an electronically captured image by means of suitable character recognition. According to an again preferred development, this is accomplished both at the front and at the rear in relation to a direction in which the vehicle drives over the measuring arrangement, in order to cover the case in which a tractor unit (that needs to be sensed at the front) has a different license number than the license number of a semi-trailer that is captured toward the rear.

This development then in turn allows the electronic further processing of the identification signal, with numerous variants and development options within the context of the present invention: thus, it is firstly advantageous and has provision made within the context of the invention to use these vehicle identification data in order to file the captured tire parameters that are to be processed electronically in a database unit in suitable fashion. These data are then in turn available for immediate or later retrieval, and it is firstly possible to output direct, vehicle-specific data in various ways, as will be described below, or alternatively to supply data aggregated for a transport fleet or similar plurality of vehicles or tires in combination to a respective user, also for further statistical evaluations. Advantageously according to the invention, the output means according to the invention have associated transaction means which may be provided for the purpose of performing a suitable payment or clearance process. Hence, it is then advantageously possible to make the operation of the inventive apparatus for capturing the tire parameters and/or outputting the captured tire parameters in the form of the display of the measurement result dependent on a (previous or later) transaction process: by way of example, it is thus possible to make a vehicle which (following the capture of the vehicle identification) is not identified or unknown the basis of a billing transaction in which a vehicle driver or keeper performs a payment process and/or inputs a suitable clearance code in order to allow the inventive display of the result of the measurement in the form of activation. By way of example, this allows the implementation of payment, voucher, promotion, discount and/or sponsoring systems, with suitable configuration of the transaction means allowing the setting up of and operation of arbitrary financial, temporal and/or technical parameters, including limitations, by a respective system user.

Preferred forms of the display of the measurement result include various output formats—also with mobile capability—for a vehicle driver or another user, and additionally or alternatively formats for a fixed data receiver. Within the context of the invention, this advantageously includes the use of suitable mobile radio data formats for the mobile transmission of the display of the result, typically in response to activation or a transaction performed using the transaction means that are advantageous on the basis of developments; said mobile radio data formats also include suitable e-mail data formats, fax data formats, or alternatively outputting by means of a printer unit onto physical media in the form of paper or the like.

A particular preference within the context of the present invention is to extend the apparatus to a client-server system in the manner of a system that is not limited to local use and to use suitable, typically public, data transmission networks (particularly the internet using suitable popular protocols) for communication between client(s) and server. It is advantageous in this context for the database unit provided on the basis of developments for the purpose of filing respective vehicle identification data and the associated measured tire parameters to be provided at the server end, while at least one client can then be provided both with the apparatus according to the invention by means of the tire pressure and tire profile depth capture means, associated evaluation means and also output means, and also typically with transaction means, which, on the basis of developments, are incorporated in the client-server system and also control and authorize the payment and clearance processes provided on the basis of developments on a system-wide basis.

In an additional development of the client-server system concept of the present invention, it is possible to provide users, typically keepers and/or persons responsible for a plurality of vehicles and vehicle tires to be measured, with direct access to the server-end database unit. This functionality, which allows the user to effect up-to-date monitoring of his vehicle fleet in respect of the tire parameters and/or additional statistical or prediction tasks, for example, could possibly also then additionally be provided by means of the transaction unit, which even then makes such server-end access operations the subject matter of transactions (that typically need to be rewarded).

In a manner which is advantageous according to the invention, the output means according to the invention for displaying the result of the measurement to the user driving the vehicle in or from a vehicle are configured such that they are a symbol signal and/or a threshold value signal. In the practical implementation, this can result in the vehicle driver being provided with signaling, for example in the manner of a typical traffic-light signal with popular signal colors (firstly for a signal which represents adequate tire parameters, and secondly inadequate or no longer tolerable tire parameters), to indicate that he needs to remedy tire defects (i.e. lack of air pressure and/or lack of tire profile depth), for example, at short notice. Such threshold-value-based presentation, typically using color coding and/or binary or symbol output, can be picked up clearly from the vehicle even by fleeting observers and does not require the vehicle driver to analyze detailed data. At the same time, it is possible, within the context of the system concept described above, to use such a threshold value signal to signal a possible defect—initially even without the need for a transaction that identifies a vehicle or that is based on a payment process—to every vehicle which has run over the capturing means, with the further consequence that (payment) transaction process is then possibly prompted in response to the threshold value signal.

Added to this is the advantageous effect that particularly when the process according to the invention is highly prevalent and the capture processes are performed frequently (simplified by driving over a shared unit), road safety ought to be significantly increased, since, according to the invention, the attention of the vehicle drivers and their awareness of vehicle defects on tires are advantageously reinforced.

As a result, the present invention therefore solves the problem arising from the prior art in a surprisingly simple and effective manner. Not only is the implementation of the present system capable of achieving a considerable time saving when checking tire parameters for individual vehicles (or else for vehicles in a fleet), the present invention also affords the opportunity for optimized use of resources in the form of tire material and fuel. Furthermore, the publicly effective and useful advantage of a tire defect in vehicles being able to be sensed more quickly and more reliably arises, which is reflected in increased road safety.

From the point of view of operators of the apparatus according to the invention, the potential arises for establishing measuring and transaction systems which, preferably with networking beyond a local site, allow considerable potential synergies which not only allow fleet customers to implement the aforementioned resource and measurement advantages but furthermore generate beneficial data material and, in a positive manner for all those involved in the system, advantageously combine economic benefit with technical benefit.

### BRIEF DESCRIPTION OF THE DRAWINGS

Further advantages, features and details of the invention can be found in the description below of preferred exemplary embodiments and also with reference to the drawings, in which:

FIG. 1 shows a block diagram of the apparatus according to the invention for measuring tire parameters for a vehicle based on a first embodiment of the present invention;

FIG. 2 shows a flowchart to explain the inventive operation of the apparatus shown in FIG. 1, and equally to illustrate the inventive method for measuring and outputting tire parameters for a vehicle based on a first form of implementation;

FIG. 3 shows a schematic block diagram to illustrate the inventive apparatus for measuring tire parameters for a vehicle based on a second embodiment of the invention;

FIG. 4 shows a flowchart to illustrate method steps in a method of operation for the apparatus shown in FIG. 3, and equally in an inventive method for measuring and outputting tire parameters for a vehicle based on a second form of implementation;

FIG. 5 shows a schematic force/displacement graph to illustrate the force profile for a tire rolling over the tire pressure capture means (to be more precise: load cells) with entry and exit as a basis for signal evaluation in order to ascertain (the effective) contact area length (a length dimension is plotted horizontally).

### DETAILED DESCRIPTION

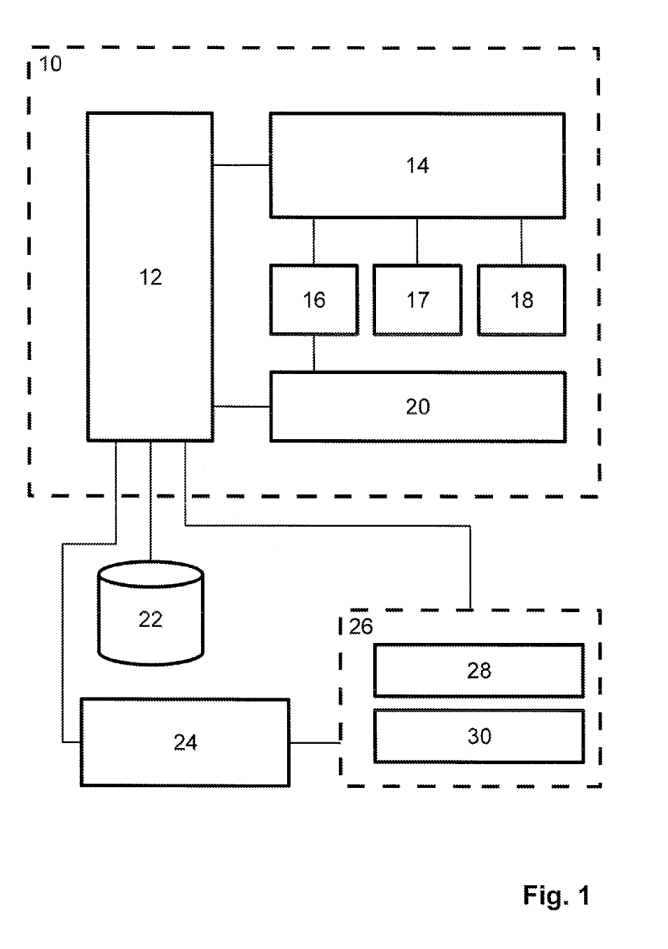

FIG. 1 shows a schematic block diagram of the apparatus for measuring tire parameters for a vehicle based on a first preferred exemplary embodiment of the present invention. This apparatus has, bordered by the dashed line 10, capture means for capturing a tire pressure 14 and also capture means for a tire profile depth 20. These means are implemented as measuring systems which are set up so as to be fixed at a predetermined site and which are typically embedded in the ground, wherein the profile depth capture unit 20 uses an optical apparatus 16 in the fashion of the manner disclosed in EP 1 952 092 in order to use laser triangulation on the basis of a plurality of lines mapped on a tire profile of a tire running over the capture means and a plurality of digitally evaluatable snapshots in this regard to measure a profile depth for this tire.

Within the context of the present invention, this optical signal, which also allows an effective profile width of the tire to be quantified, in particular, for example in the manner described in the above document, is additionally used in order to determine the tire pressure using the unit 14. According to preferred forms of implementation of the invention, this is accomplished by virtue of the tire rolling over a system of load cells in the measuring apparatus described, and an effective length of a contact face of the relevant tire on the ground beneath (“contact area”) then being able to be established from the profile of the signal produced by the load cells (to be more precise: a coupled plurality of force sensors using a shared pressure plate that is provided in order to be run over).

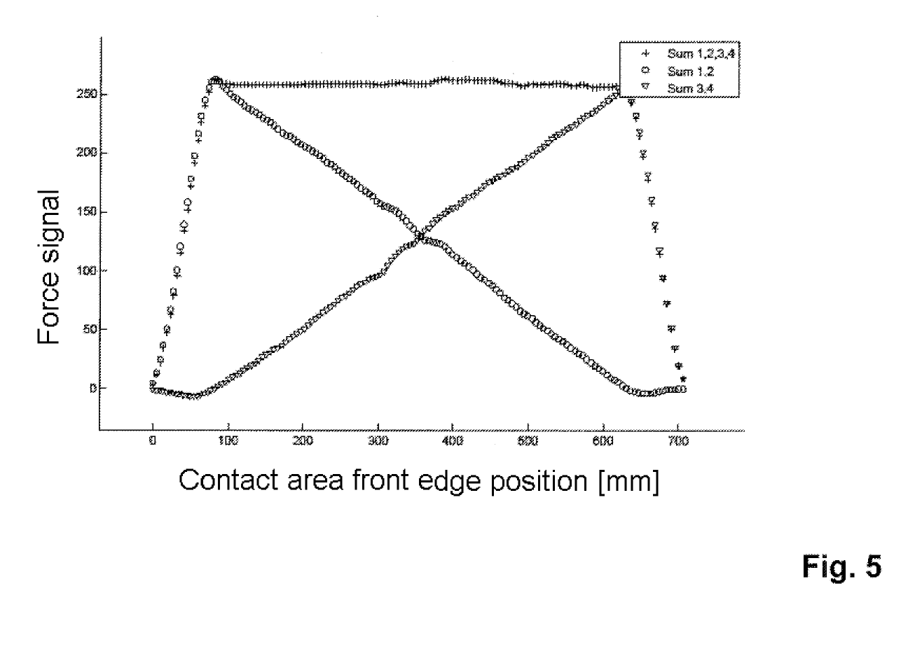

To be more precise, and with preference to the signal graph in FIG. 5, a tire rolling over the load cells (to be more precise: a system of coupled load cells as a result of a shared, overlying pressure plate being rolled over) produces a force/time signal profile as shown in the illustration in FIG. 5; thus, in the superimposition, FIG. 5 shows a force/displacement signal from a first load cell pair (connected in the axle direction, i.e. in the direction transverse to the direction of travel) and also from a correspondingly connected second load cell pair, offset in the longitudinal direction (i.e. the direction of travel). Accordingly, the respective force/displacement profiles reproduce the respective roll-on and roll-off and the impingement of the tire up to a maximum force, with respectively different edge profiles, based on leading and a lagging sensor pair. The respectively steep edges are then the basis for the aforementioned determination of an effective contact area length, with a final effective contact area length then being ascertained from the shorter rising edge of a first, leading sensor pair and a falling edge of a second, trailing sensor pair in the manner described above by means of addition. In this case, the “length” is understood to mean a first dimension of the contact area face in the direction of travel, and “effective” is understood to mean those ranges in which a force input into the load cells is at a maximum, in accordance with a linear or approximately linear rise in the signal in FIG. 5 upon driving onto the capturing means (and falling when driving off). Otherwise known signal evaluation techniques which do not need to be explained in more detail at this juncture establish the linear range (accordingly in this case also inventively the range of the approximately maximum gradient). Advantageously in accordance with the invention, it has then be found that this range can then be used, as described, directly to ascertain the desired (effective) contact area length.

Accordingly, the present contact area length ascertainment is based on a one-dimensional force profile evaluation over time (or over the corresponding location, fixed by the associated length of the load cell plate).

An effective contact area width that is associated with ascertaining the contact area face is effected optically in the manner which will be described below, and without influencing the load cells described.

The profile width signal which is produced optically by the unit 16 and which roughly corresponds to the contact area width therefore provides the entire contact area face (width multiplied by length) for the purpose of determining the tire pressure. The force signal—which is in turn available from the force sensor—for the force vector (based on the contact area face) directed onto the ground beneath by the tire then allows the direct derivation of the tire pressure, with empirical correction values, typically filed in table form, for tire parameters initially also being used. Hence, it is then possible to perform tire pressure measurement which is based on the ascertainment of the contact area face, insofar as it works in a technically simple manner and quickly. The circumstance that the optically ascertained contact area width means that there is a potential and theoretically possible different pressure distribution in the width (i.e. transverse with respect to the direction of travel) cannot be ascertained with this technology, but has been found to be negligible in the practical implementation and to this extent is ignored in the present case.

According to the present invention, the tire pressure determination additionally uses a current tire temperature value which is measured contactlessly on the tire by the unit 17 (specifically: in a manner directed onto a tire side by means of infrared temperature measurement, for example), as a result of which the temperature dependency of the tire pressure is factored in.

In this way, the capture means are then able to use a central processing unit 12 to aggregate the data obtained in this manner and to route them to subsequent storage in a memory unit 22.

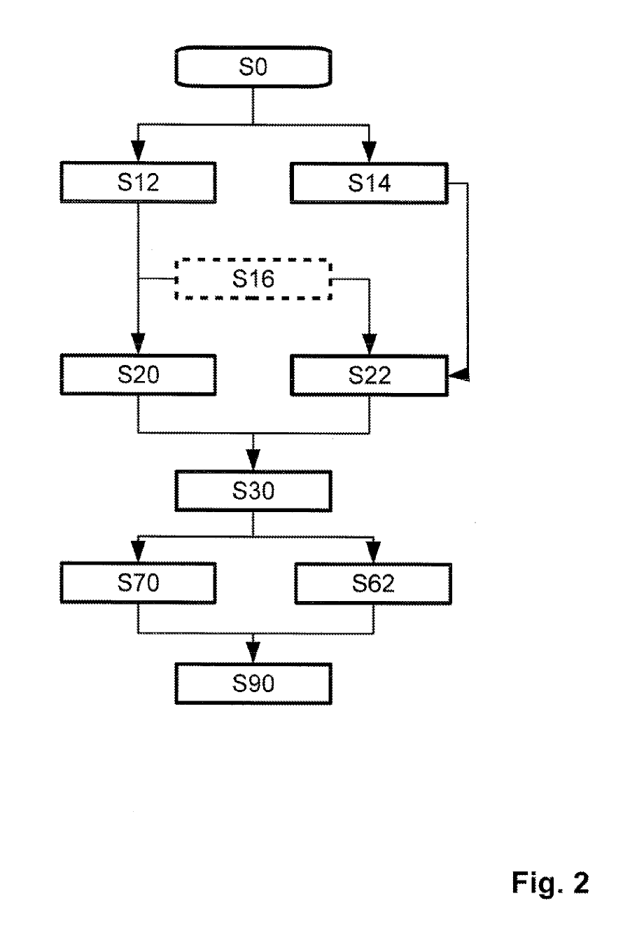

The sequence of these processing steps is illustrated in parallel by the flowchart shown in FIG. 2: in step S0, the vehicle having the tires to be measured drives onto the measuring apparatus (this being able to be designed both for a single tire and for an axle, i.e. having two tires carried parallel to one another, and in the second case the optical means 16, the temperature capture means 17 and the force capture means 18 then accordingly being provided in a manner suitably doubled for each side).

In steps S12 and S14, the optical measurement (S12) then takes place in the manner described above by virtue of the execution of a plurality of sequential image capture operations (typical sequence approximately 5 msec), and the contactless temperature measurement (S14) can actually take place approximately in parallel therewith.

These measured values are then combined in the determination steps S20 in order to determine the profile depth from the optical data or in order to determine the tire pressure from the optically sensed profile or tire width and also temperature corrective. Advantageously and optionally, step S16 may also involve a force measurement predetermined using the unit 18, with an alternative form of implementation of the invention providing for a contact area length also to be able to be ascertained solely by virtue of the optical width signal, which is sequential and is present as a sequence of individual measurements. Specifically, if the geometry of an image window, for example, which is used to capture a current imaging of the tire profile that is running over the capture is known, it would be possible to take the sequence of the individual images (for a profile pattern which then successively fills the image window and the profile pattern which clears it again) and knowledge of a shot frequency and to use appropriate geometric evaluation in order to determine a contact area length in accordance with the roll-over process, in addition to the contact area width which, of course, is detected from the image directly in the transverse direction anyway, and with the further option of establishing from the image a possible contact area shape, e.g. the result of a distinct underpressure and associated tire deformation.

Both measured values are then provided as a suitable data record for the tire parameters in step S30 for the purpose of further processing, particularly initially for the purpose of data storage in accordance with step S62.

According to the first embodiment of the present invention, an output and transaction functionality is implemented, beyond the capture means 10: thus, the first exemplary embodiment provides output means as functional unit 26, which output means are able to output the tire parameters to a user in two ways: firstly, symbol and/or threshold value means are provided in the form of the unit 28 which, in the manner of traffic lights or the like, for example, are able to signal to a user in the vehicle itself (that is to say for observation from an HGV cockpit, for example) whether the tire parameters ascertained as the result of running over the capture means—tire profile depth and tire pressure—correspond to the predetermined limit and threshold values, that is to say still comply with the legally required standard, for example, and/or represent a minimum tire air pressure that is beneficial in terms of use. This could then prompt a green signal from the symbol and threshold value output, for example. By contrast, one or both of the tire parameters dropping below a predetermined threshold value, for example, would produce a “red light” symbol and hence signal to the vehicle driver that further steps are necessary. Within the context of the present structure, it is particularly also possible to make an output by the unit 28, for example in the form of the traffic lights described for simplification purposes, independently of a preceding authorization or payment transaction, and in fact to provide a driver with said output at any time and at no cost, for example.

Alternatively, the invention allows the output by the unit 28 and also, in addition, an output by the unit 30 to be made dependent on clearance by an upstream transaction unit 24. By way of example, this transaction unit, under the actuation of the processing unit 12, is capable of responding to a transaction that is to be performed (for example the reception of clearance data, the performance of a payment process or the like) by allowing the activation of the output unit 26 or portions thereof in the first place.

In the specific implementation, it could mean a code input apparatus for the transaction unit 24, or alternatively also a credit card payment or checkout system, for example, which makes it necessary for a transaction to be concluded positively by a user or in another way, for example by means of data input or transmission, before an output is made possible. In the form of implementation described above (initially with a simple configuration) for the first exemplary embodiment in FIG. 1, this could be implemented such that although the symbolic output of the unit 28 is made possible without a prior transaction, if the HGV driver were to learn from the example which tire parameters are erroneous and which values they have, for example, then he could initiate a printout using the output unit 30, which in this example then has a suitably configured printer for output on a paper medium, only by input or of a clearance code into the suitably configured transaction unit.

As a result, just this first, simple form of implementation of the invention allows the principle of integrated profile depth and tire pressure measurement, which is advantageous according to the invention, to be embedded into a transaction and output system, which makes all the necessary information available in situ and in a manner satisfactory for the user to the respective party with an interest in the tire parameters and uses the transaction unit 24 to provide a user, for example, with the opportunity to perform suitable version control for this output.

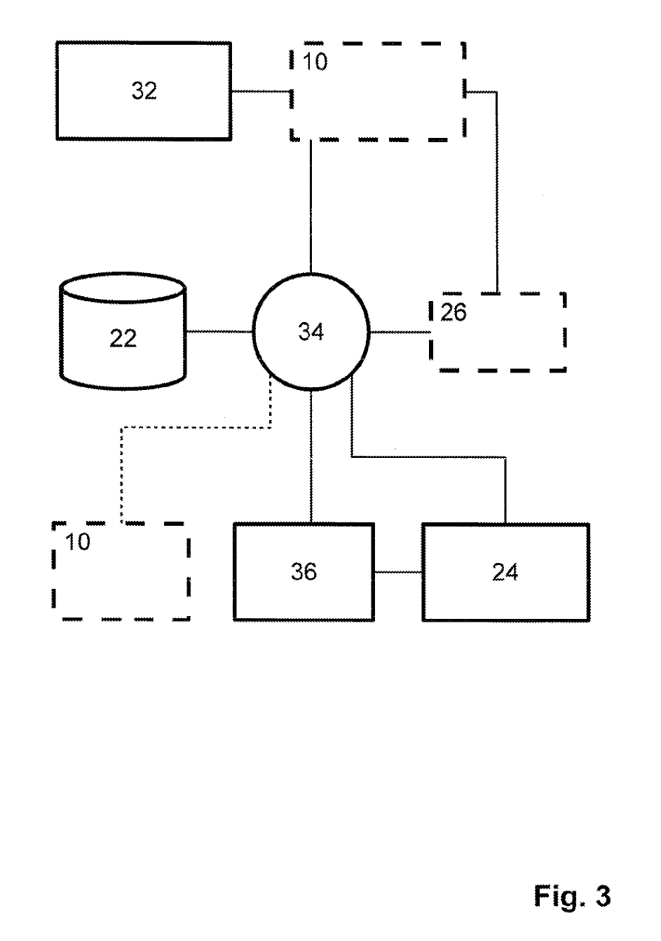

The first exemplary embodiment in FIG. 1, and also the exemplary embodiment in FIG. 3, which will be explained below, is more complex and is embedded in a data network, additionally allow—in a simple development—the identification and authorization of a user (or a vehicle on which the measuring process is based; this is based on the assumption that usually a tire is always accessible to the measuring apparatus in the state mounted on the associated vehicle and passes through the method according to the invention). Such an identification unit, which is not shown in FIG. 1 and is denoted by the reference symbol 32 in FIG. 3, would typically be able to be implemented as an arrangement with at least one image capture unit, which is directed at the license number of the vehicle as a camera (with further preference implemented as a pair of two camera units, respectively directed at a front and a rear license number of the vehicle, with the purpose of being able to capture possibly different license numbers of a traction unit and a semi-trailer). From such an image capture signal, methods of image and character recognition are then used in otherwise known fashion to produce an identification signal for the vehicle in question (and additionally for a semi-trailer with a separate license number), namely in the form of the license plate number. This serves to explicitly identify this vehicle and can then be filed together with the tire parameters in the data memory unit 22 and also be used an index in this case, for example. In this context, the term “identification unit” should be consciously understood in a broad and functional manner rather than being limited to the functional implementation by means of an image capture unit. Instead, in such a functionality can be implemented by numerous further identification technologies, for example RFID, suitable magnet coding, capture of tarpaulin logos which are typically present on a fleet of HGVs or similar encryptions.

The modification described affords the advantage over the simplified version in FIG. 1 that it is actually possible to produce and use vehicle-specific data without a user, for example, needing to input a motor vehicle license number into the transaction unit 24, and without separate manual clearance processes needing to be performed for each process, for example. By way of example, there could thus be a configuration to the effect that the transaction unit 24, in interaction with an identification unit, uses a predetermined and stored table of license numbers to obtain the information regarding those vehicles for which there is already clearance for the output of the respective data, e.g. on the basis of an upstream purchase transaction.

The possibilities of such identification in connection with arbitrary transaction configurations are almost unlimited; thus, it is firstly possible to actually clear vehicles (and hence the tires thereof) for unlimited measurement and data output in the previously described manner on a customer or fleet basis, with the result that to this extent any processing times are limited to the mere drive-through and possibly receipt of a written log or the like; as an additional simplification, such an output could also be provided by then making data records available to the vehicle driver himself or other data recipients wirelessly or by wire in otherwise known fashion by means of mobile radio, e-mail or other means.

Alternatively or in addition, the configurability provides the option of also allowing transactions on a differentiated basis in another way, for example triggering transactions flexibly in the form of codes that can be allocated free of charge, suitable times for cheaper participation in the measuring process (“Happy Hour”), by virtue of coupons or other promotional measures or the like. One development of the transaction unit could also allow the conditions for data output to be varied according to the environment and on the basis of the situation, e.g. appropriate pricings to be made on the basis of holidays or the weather, or else the way in which the respective output modes for the tire parameters are configured to be influenced in a specific manner (e.g. HGVs or trailer combinations to be associated with different forms of output than cars, for example).

Besides the described development of the exemplary embodiment in FIG. 1 by virtue of the identification unit 32, the second exemplary embodiment in FIG. 3 has a further, fundamental modification in comparison with the first exemplary embodiment—which can be presented primarily on a local basis—shown in FIG. 1: it schematically shows how a plurality of sensor units 10 can also be networked beyond a local standard in the manner of a (preferably public) data network 34 (typically the internet, for example, which can be operated by means of suitable IP formats).

Thus, the exemplary embodiment in FIG. 3 merely uses the symbol block 10 to show, again, a capture unit which exists at a first site and which is configured in the manner of FIG. 1, so that it is set up to be run over by a vehicle carrying the tires that are to be measured. This capture unit 10 may then preferably have the already discussed identification unit 32 locally associated with it, for example in order to be able to automatically identify a relevant vehicle, and hence potentially authenticate it, in the advantageous manner. A form of output based on output unit 26 is also implemented preferably locally, for example typically at least in the form of the symbol or threshold value display 28, or alternatively also further means.

Suitably, the data memory unit 22 in the illustration in FIG. 3 is then centralized preferably at the server end so as to firstly make it available to all local sensor units, which can be understood as clients. Furthermore, the transaction unit 24 would preferably also be centralized at the server end via the network, or alternatively may also additionally or exclusively be provided locally at the client end in each case. In addition, such a client-server network system allows suitable partners, e.g. fleet customers, to provide direct access to the data memory unit 22 via the electronic data network 34. By way of example, this may be useful when portions of the customer-end fleet management, for example the management of the tire parameter data, are intended to have functions relocated to the present system. In this case, the transaction unit 24 would authorize a party that uses the unit 36 for access.

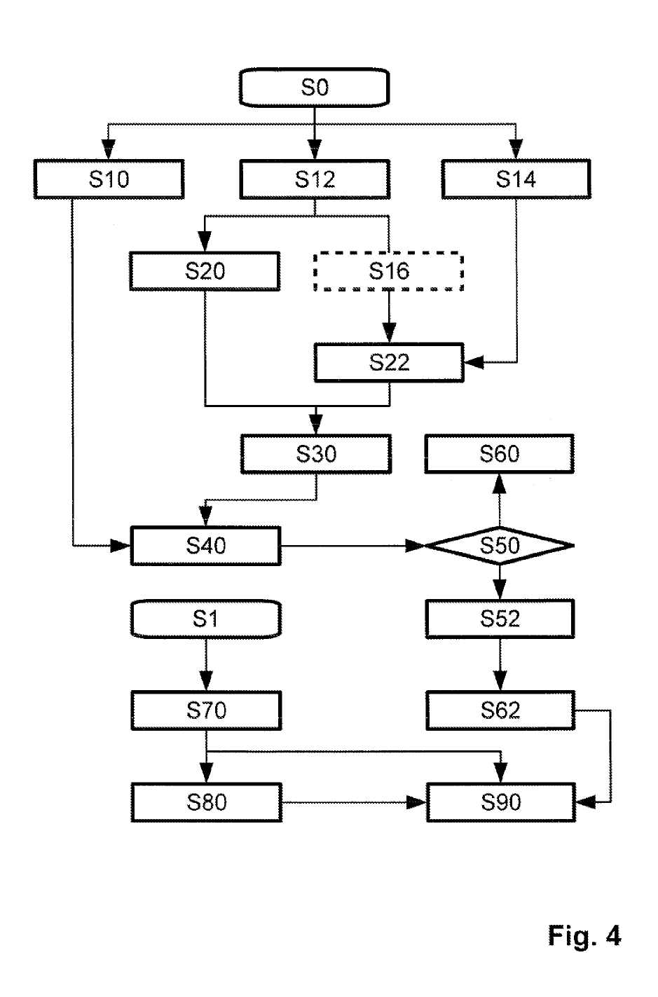

The block diagram in FIG. 4 illustrates the manner of operation of and the method for operating the apparatus shown in FIG. 3, wherein, in similar fashion to the first exemplary embodiment in FIGS. 1 and 2, appropriate method steps, and also appropriate function blocks, bear corresponding step labels and reference symbols. Thus, again after the vehicle carrying the tires to be measured has driven onto or driven into the measuring apparatus (S0), the optical measurement (S12) and also the temperature measurement (S14) take place, and in parallel therewith the vehicle identification (S10) by virtue of a shot of the license plate number and processing to form a license plate number data record. In the manner described previously, processing steps S20 and S16/S22 then allow the profile depth determination and the tire pressure determination with optionally upstream force measurement, so that on the basis of step S30 the tire parameters are available for further storage and transmission. In step S40, they are combined with the results of the vehicle identification (S10), which means that it is then possible to establish in decision step S50 whether a signal is output for the output unit (to be more precise: threshold value unit 28). Processing steps S52 and S62 then transmit the tire parameter data records provided with an identifier (license number) identifying vehicle to the memory unit 22 via the data transmission network, and said data records are filed in said memory unit in step S62. For (value added) output, a user, for example, then has the option of requesting data in suitable fashion in step S1 and performing an associated authorization or payment transaction (step S70), whereupon the contents of the data memory are then retrieved in suitably selected form in step S80 and output in the suitable and particular manner in step S90. In this case, such a user routine is suitable both for a local transaction (in similar fashion to the approach shown in FIG. 1) and for remote access by a fleet user in similar fashion to the access by the unit 36, and for the performance of further transaction and output modes that can be designed in flexible fashion, as described above.

Hence, it is possible to configure the present unit, for example, in order to implement a typical commercial principle “everyone contains only the data for which he pays”. At the same time, depending on the current configuration, this principle can then be refined or adapted in suitable fashion. In the technical implementation, the identification unit (reference symbol 32) allows automatic association with transactions (payment processes) that have already been performed, and in the case of capture errors or changes sensed overall, and not yet in the system, for example, requests are then sent in suitable fashion by the system or requirements are output for the transaction unit to be used to perform fresh identification, to input clearance data on an updated basis or to renew any existing subscription or similar conversation structure.

While there are basically arbitrary options for the design of particularly the data transmission between the various units and entities in the exemplary embodiment in FIG. 3, preferred forms of implementation make it possible to use largely standardized data formats and protocols (e.g. XML data formats) so as to provide the simplest compatibility with existing database infrastructure (for example for the implementation of the data memory unit 22) and/or data transmission protocols in this respect. Externally accessing users (reference symbol 36) are also thus provided with the opportunity to then use and evaluate data using largely standardized access tools.

Although the present invention provides for the storage of measurement data (possibly also after an interposed step to check for measurement or capture errors), in principle, so as in this respect to be able to capture historic and statistical data which may in turn be the basis for future refined evaluation models or the like. Embodiments of the present invention alternatively include the erasure of captured data after the method according to the invention has ended, in order to be able to comply with any regulations pertaining to anonymization and/or data protection.

Finally, the functionality of the present apparatus, particularly of the transaction unit 24, includes also performing downstream or remote transaction processes in the form of debit operations, direct debit payment processes or the like. By way of example, following identification of a vehicle as belonging to a previously known pool of HGV fleet participants, it would be possible for the transaction unit 24 to be used such that, in response to the apparatus according to the invention being run over in situ and the tire parameters subsequently being sensed and output, a payment sum which has been predetermined or agreed for this purpose is initiated as a debit payment transaction.

Further modification and development options are almost unlimited. Thus, by way of example, the transaction and/or output unit allows flexible reaction to vehicles, and additionally or alternatively also, for example in response to the capture of a foreign license plate, automatic association of the output of a printed or visually produced information medium in the respective associated national language.

As a result, the present invention allows—in a surprisingly simple manner which can be adapted flexibly and almost to any requirements—the traditionally static and time-consuming process, requiring manual actions, of measuring and capturing tire parameters for a vehicle, particularly a commercial vehicle, to be integrated into a system which not only allows the capture and saving of these desired data merely by simply running over a form of implementation of the apparatus according to the invention so that considerable advantages in terms of flexibility and time are realized, furthermore allows arbitrary adaptability also to large, cross-regional systems within the context of peripheral designs of output, transaction and networking. It is therefore possible to serve almost any customers with a visible added value, which means that it can be expected that the present invention of automated tire profile and tire pressure inspection opens up additional areas of use, combined with the positive effects on resource saving and public or road safety.

1-15. (canceled)

16. An apparatus for measuring tire parameters for a vehicle comprising means for capturing a tire pressure for a tire of a vehicle, means for capturing a tire profile depth for the tire of the vehicle and means for outputting measured tire parameters including the tire pressure and the tire profile depth, wherein the tire pressure capture means and the tire profile depth capture means have a measuring arrangement which is designed to be run over by the vehicle and which is configured to measure the tire pressure and also the tire profile depth when the vehicle is moving, and the output means are designed to display a result of the measurement so that a user driving the vehicle can capture the measurement from the vehicle after running over the measuring arrangement, the output means are designed to transmit the result of the measurement to a data receiver unit using an electronic data transmission network, wherein the tire pressure capture means and the tire profile depth capture means are designed such that the tire pressure is measured and the tire profile depth is measured by virtue of the shared use of optical measuring means for both measuring processes.

17. The apparatus as claimed in claim 16, wherein the tire pressure capture means and the tire profile depth capture means are adapted so that the tire pressure is measured and the tire profile depth is measured during the same run-over process by the vehicle using the shared measuring arrangement.

18. The apparatus as claimed in claim 16, further including contactlessly acting means for capturing the tire temperature which is associated with the tire pressure capture means for the purpose of temperature compensation for the measurement of the tire pressure and execute the temperature capture during the same run-over process by the vehicle.

19. The apparatus as claimed in claim 16, further including a vehicle identification unit which is designed to capture a vehicle identification before, during or after the run-over process by the vehicle and is associated with the measuring arrangement.

20. The apparatus as claimed in claim 19, wherein the vehicle identification unit has optical image capture means for capturing at least one of the license plate numbers of the vehicle and for producing electronically processable vehicle identification data therefrom.

21. The apparatus as claimed in claim 16, further including an electronic database unit, which interacts with the output means, for vehicle keeper data and/or vehicle parameter data which is associated with a vehicle identification of the vehicle.

22. The apparatus as claimed in claim 21, wherein the electronic database unit is adapted to file the results of the measurement for an identified vehicle.

23. The apparatus as claimed in claim 22, further including transaction means, which are associated with the output means, for performing a payment and/or clearance process which are designed such that predetermined formats and/or forms of output of the results of the measurement are produced, displayed or transmitted only following the conclusion of a payment transaction or an electronic clearance transaction.

24. The apparatus as claimed in claim 23, wherein the formats or forms of output include mobile radio data formats, e-mail data formats, fax data formats and a printout on a physical medium.

25. The apparatus as claimed in claim 23, wherein the tire pressure capture means, the tire profile depth capture means and the output means form a local and client-end measuring and processing unit to which the database unit is linked and is accessed locally at the server end via the electronic data transmission network within the context of a client-server system.

26. The apparatus as claimed in claim 25, wherein the transaction means are incorporated in the client-server system.

27. The apparatus as claimed in claim 26, wherein the client-server system is designed so that an interrogation unit provided at the client end can access the results of the measurement that are stored on a vehicle-specific basis in the database unit, following the performance of an authentication process.

28. The apparatus as claimed in claim 25, wherein the output means are designed to produce and output a threshold value signal which can be captured visually and/or audibly by the user and which classifies the result of the measurement of the tire pressure and of the tire profile depth relative to predetermined threshold values and reproduces it in a form having a reduced volume of data, in digital and/or traffic-light form.

29. The apparatus as claimed in claim 16, wherein the output means has a printer unit for producing an output of the results of the measurement on a paper or plastic medium.

30. A method for measuring and outputting tire parameters for a vehicle including tire pressure and tire profile depth, comprising the following steps:
capturing a tire pressure for a vehicle while the vehicle is moving;
capturing a tire profile depth for the vehicle while the vehicle is moving;
outputting a result for the captured tire pressure and tire profile depth, wherein the tire pressure and the tire profile depth are captured during a single movement process by the vehicle by running over a measuring arrangement comprising an optical measuring means for both measuring processes; and
forwarding the outputted result to a user driving the vehicle, wherein the result is sent to a data receiver unit by means of a public electronic data transmission network.
